(19) United States
(12) Patent Application Publication
(10) Pub. No.: US 2026/0112674 A1
(43) Pub. Date: Apr. 23, 2026

(54) FUEL CELL SYSTEM

(71) Applicant: TOYOTA JIDOSHA KABUSHIKI KAISHA, Toyota-shi (JP)

(72) Inventor: Satoshi SHIOKAWA, Okazaki-shi (JP)

(73) Assignee: TOYOTA JIDOSHA KABUSHIKI KAISHA, Toyota-shi (JP)

(21) Appl. No.: 19/215,885

(22) Filed: May 22, 2025

(30) Foreign Application Priority Data
Oct. 18, 2024 (JP) 2024-184282

(51) Int. Cl. H01M 8/0662; H01M 8/04082; H01M 8/04111; H01M 8/04746

(52) U.S. Cl. CPC H01M 8/0662; H01M 8/04111; H01M 8/04201; H01M 8/04753; H01M 8/04761; H01M 2250/20

(57) ABSTRACT

A fuel cell system includes a fuel cell, an air supply pipe that supplies an oxidizing gas to the fuel cell, an exhaust pipe that discharges an off-gas discharged from the fuel cell to the outside, a muffler provided in the exhaust pipe, and a control device that executes muffler protection control when an estimated value of a pressure in the muffler exceeds a predetermined threshold value.

### CROSS-REFERENCE TO RELATED APPLICATION

This application claims priority to Japanese Patent Application No. 2024-184282 filed on Oct. 18, 2024. The disclosure of the above-identified application, including the specification, drawings, and claims, is incorporated by reference herein in its entirety.

### BACKGROUND

### 1. Technical Field

The technique disclosed in the present specification relates to a fuel cell system.

### 2. Description of Related Art

Japanese Unexamined Patent Application Publication No. 2006-331884 (JP 2006-331884 A) discloses a fuel cell system. The fuel cell system of JP 2006-331884 A includes a fuel cell that generates power by receiving a supply of a reaction gas and discharges a reaction off-gas, a gas passage through which the reaction gas or the reaction off-gas flows, a valve device provided in the gas passage, and a control device that controls an opening degree of the valve device. The control device acquires a downstream pressure of the valve device when the fuel cell system is activated, and in a case where the downstream pressure is equal to or lower than a predetermined pressurization completion pressure, the control device performs duty control of the valve device at a predetermined duty ratio.

### SUMMARY

In the fuel cell system, a muffler may be provided in an exhaust pipe in order to suppress a sound generated by the off-gas discharged from the fuel cell. In this configuration, in a case where the exhaust pipe is temporarily in a closed state or a half-closed state due to freezing or the like, there is a possibility that the muffler may be damaged due to an increase in pressure in the muffler when air is supplied to the fuel cell. Therefore, the present specification provides a technique capable of preventing the muffler from being damaged.

According to a first aspect of the present technique,
a fuel cell system includes
a fuel cell,
an air supply pipe configured to supply an oxidizing gas to the fuel cell,
an exhaust pipe configured to discharge an off-gas discharged from the fuel cell to an outside,
a muffler provided in the exhaust pipe, and
a control device configured to execute muffler protection control when an estimated value of a pressure in the muffler exceeds a threshold value that is predetermined.

With this configuration, when the estimated value of the pressure in the muffler exceeds the threshold value, it is possible to suppress the excessive pressure rise in the muffler by executing the muffler protection control. As a result, it is possible to prevent the muffler from being damaged.

According to a second aspect,
in the first aspect,
the fuel cell system may further include
a compressor provided in the air supply pipe, the compressor being configured to pressurize the oxidizing gas supplied to the fuel cell, and
a pressure sensor configured to detect a pressure of the oxidizing gas pressurized by the compressor.
   The control device may be configured to calculate the estimated value of the pressure in the muffler based on the detected pressure of the pressure sensor.

According to a third aspect,
in the second aspect,
the control device may be configured to execute the muffler protection control by reducing a rotation speed of the compressor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a fuel cell system of an embodiment;

FIG. 2 is a flowchart (1) of processing executed by the control device of the embodiment; and

FIG. 3 is a flowchart (2) of the process executed by the control device of the embodiment.

### DETAILED DESCRIPTION OF EMBODIMENTS

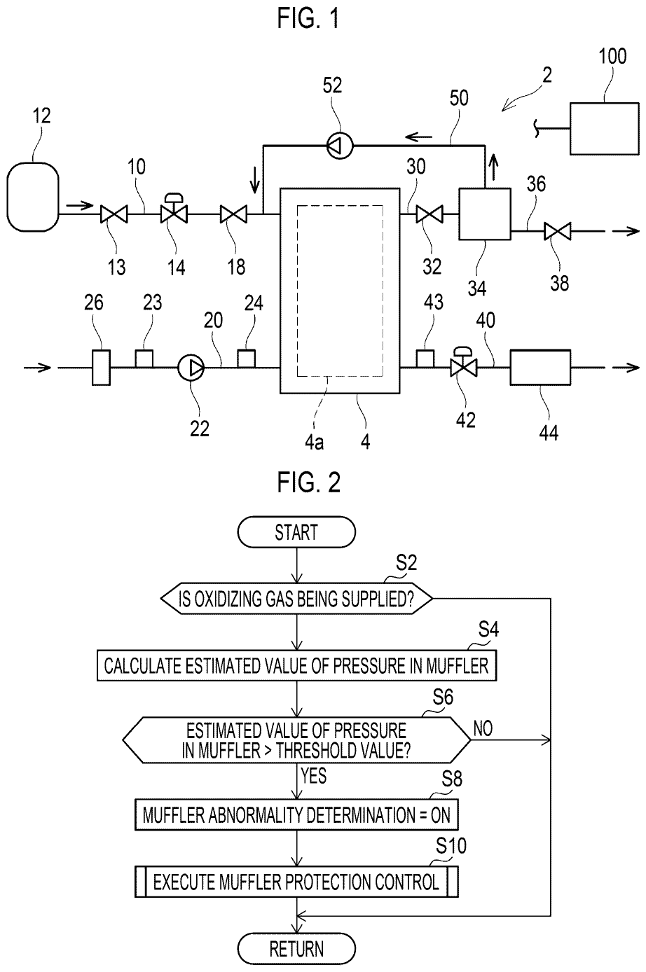

The fuel cell system 2 of the embodiment will be described with reference to the drawings. As shown in FIG. 1, the fuel cell system 2 of the embodiment includes a control device 100, a fuel cell 4, and a first air supply pipe 10, a second air supply pipe 20, a first exhaust pipe 30, and a second exhaust pipe 40 connected to the fuel cell 4. In addition, the fuel cell system 2 includes a drain pipe 36 and a circulation pipe 50.

The fuel cell system 2 is mounted on, for example, a fuel cell electric vehicle and supplies electric power to a motor for traveling of the fuel cell electric vehicle. The fuel cell system 2 may be used for a vehicle other than the fuel cell electric vehicle. For example, the fuel cell system 2 may be used in a stationary electric power supply device.

The control device 100 of the fuel cell system 2 includes, for example, a CPU, a ROM, and a RAM, and executes control or processing related to the fuel cell system 2 based on a predetermined program. The control or the process executed by the control device 100 will be described later.

The fuel cell 4 is a device that generates electricity by a chemical reaction between hydrogen contained in fuel gas and oxygen contained in an oxidizing gas. The fuel cell 4 includes a stack 4a configured by a plurality of single cells. The fuel cell 4 includes one or a plurality of stacks 4a. The configuration of the fuel cell 4 is already known, and thus a detailed description thereof will be omitted.

The first air supply pipe 10 has an upstream end connected to a tank 12 of fuel gas (for example, gas containing hydrogen) and a downstream end connected to the fuel cell 4. The first air supply pipe 10 supplies the fuel gas stored in the tank 12 to the fuel cell 4. The tank 12 stores fuel gas to be supplied to the fuel cell 4 in a high pressure state.

The first air supply pipe 10 is provided with a tank valve 13, a pressure regulating valve 14, and an inlet valve 18 in this order from the upstream side. When the tank valve 13, the pressure regulating valve 14, and the inlet valve 18 are in the open state, fuel gas is supplied from the tank 12 to the fuel cell 4.

The pressure regulating valve 14 adjusts (reduces) the pressure of the fuel gas in the first air supply pipe 10 such that the pressure of the fuel gas on the downstream side of the pressure regulating valve 14 is lower than the pressure of the fuel gas on the upstream side of the pressure regulating valve 14.

The second air supply pipe 20 has an upstream end opened to the outside of the fuel cell system 2 and a downstream end connected to the fuel cell 4. The second air supply pipe 20 supplies the oxidizing gas (for example, air containing oxygen) supplied from the outside to the fuel cell 4. The second air supply pipe 20 is provided with a filter 26, a flow rate sensor 23, a compressor 22, and a pressure sensor 24 in this order from the upstream side.

The filter 26 removes foreign matter (for example, dust) contained in the oxidizing gas supplied to the fuel cell 4 through the second air supply pipe 20. The flow rate sensor 23 detects a flow rate of the oxidizing gas flowing through the second air supply pipe 20. That is, the flow rate sensor 23 detects the flow rate of the oxidizing gas supplied to the fuel cell 4 through the second air supply pipe 20. The compressor 22 pressurizes the oxidizing gas and transmits the oxidizing gas to the downstream side of the second air supply pipe 20. That is, the compressor 22 pressurizes the oxidizing gas supplied to the fuel cell 4. The pressurized oxidizing gas is supplied to the fuel cell 4 through the second air supply pipe 20 by the operation of the compressor 22. The pressure sensor 24 detects a pressure of the oxidizing gas in the second air supply pipe 20. That is, the pressure sensor 24 detects the pressure of the oxidizing gas supplied to the fuel cell 4 through the second air supply pipe 20.

The first exhaust pipe 30 has an upstream end connected to the fuel cell 4 and a downstream end connected to the gas-liquid separator 34. The first exhaust pipe 30 discharges the off-gas of the fuel gas discharged from the fuel cell 4 to the gas-liquid separator 34. The off-gas of the fuel gas contains gaseous hydrogen and liquid water. An outlet valve 32 is provided in the first exhaust pipe 30, and when the outlet valve 32 is in an open state, the off-gas of the fuel gas is discharged from the fuel cell 4 to the gas-liquid separator 34. The gas-liquid separator 34 separates the gas (hydrogen) and the liquid (water) contained in the off-gas of the fuel gas.

The drain pipe 36 has an upstream end connected to the gas-liquid separator 34 and a downstream end opened to the outside of the fuel cell system 2. The drain pipe 36 discharges the liquid (water) separated in the gas-liquid separator 34 to the outside of the fuel cell system 2. An on-off valve 38 is provided in the drain pipe 36, and when the on-off valve 38 is in an open state, a liquid (water) is discharged from the gas-liquid separator 34 to the outside of the fuel cell system 2. The downstream end of the drain pipe 36 may be connected to the second exhaust pipe 40.

The circulation pipe 50 has an upstream end connected to the gas-liquid separator 34 and a downstream end connected to the first air supply pipe 10. A downstream end of the circulation pipe 50 is connected to the first air supply pipe 10 on the downstream side of the inlet valve 18. The circulation pipe 50 supplies the gas (hydrogen) separated in the gas-liquid separator 34 to the first air supply pipe 10. The circulation pipe 50 is provided with a compressor 52, and when the compressor 52 operates, the gas (hydrogen) separated 15 in the gas-liquid separator 34 is supplied to the first air supply pipe 10.

The second exhaust pipe 40 has an upstream end connected to the fuel cell 4 and a downstream end opened to the outside of the fuel cell system 2. The second exhaust pipe 40 discharges the off-gas of the oxidizing gas discharged from the fuel cell 4 to the outside of the fuel cell system 2. In the second exhaust pipe 40, a temperature sensor 43, a pressure regulating valve 42, and a muffler 44 are provided in this order from the upstream side.

The temperature sensor 43 detects the temperature of the off-gas flowing through the second exhaust pipe 40. That is, the temperature sensor 43 detects the temperature of the off-gas discharged from the fuel cell 4 through the second exhaust pipe 40. The pressure regulating valve 42 adjusts (reduces) the pressure of the off-gas in the second exhaust pipe 40 such that the pressure of the off-gas on the downstream side of the pressure regulating valve 42 is lower than the pressure of the off-gas on the upstream side of the pressure regulating valve 42. The pressure regulating valve 42 regulates the pressure of the off-gas in the second exhaust pipe 40 such that the pressure of the oxidizing gas in the fuel cell 4 becomes an appropriate pressure.

The muffler 44 is a device that suppresses a sound generated due to the off-gas flowing through the second exhaust pipe 40. The configuration of the muffler 44 is not particularly limited. The muffler 44 includes, for example, a casing and a sound-absorbing material filled in the casing. In another example, the muffler 44 may have a meandering flow path, and the muffler 44 may have a configuration in which the sound generated due to the off-gas is suppressed by the off-gas passing through the flow path. The off-gas passing through the muffler 44 is discharged to the outside of the fuel cell system 2.

Next, control or processing executed by the control device 100 will be described with reference to FIG. 2. The processing shown in FIG. 2 is started, for example, when a predetermined execution start instruction is input. As shown in FIG. 2, in S2 of the process, the control device 100 determines whether the oxidizing gas is supplied to the fuel cell 4. Specifically, the control device 100 determines whether the compressor 22 provided in the second air supply pipe 20 is in operation. When the compressor 22 is operating (YES in S2), the process proceeds to S4, and when the compressor 22 is not operating (NO in S2), the process of FIG. 2 ends.

In S4 after YES in S2, the control device 100 calculates an estimated value of the pressure in the muffler 44 provided in the second exhaust pipe 40. For example, the control device 100 calculates an estimated value of the pressure in the muffler 44 based on the detected pressure of the pressure sensor 24, the pressure loss in the fuel cell 4, the pressure loss in the pressure regulating valve 42, and the pressure loss in the second exhaust pipe 40.

At this time, the pressure loss in the fuel cell 4 is calculated based on, for example, the flow rate of the oxidizing gas and the temperature of the off-gas of the oxidizing gas. The control device 100 calculates the pressure loss in the fuel cell 4 based on, for example, the detected flow rate of the flow rate sensor 23 provided in the second air supply pipe 20 and the detected temperature of the temperature sensor 43 provided in the second exhaust pipe 40. In a modification, the pressure loss in the fuel cell 4 may be calculated based on the rotation speed of the compressor 22 and the detected temperature of the temperature sensor 43. In another modification, the pressure loss in the fuel cell 4 may be calculated based on the detected flow rate of the flow rate sensor 23 and the temperature of the coolant in the fuel cell 4. The temperature of the coolant in the fuel cell 4 is detected by a separate temperature sensor provided in the fuel cell 4.

The pressure loss in the pressure regulating valve 42 is calculated based on, for example, the flow rate of the oxidizing gas, the temperature of the off-gas of the oxidizing gas, and the opening degree of the pressure regulating valve 42. The control device 100 calculates the pressure loss in the pressure regulating valve 42 based on, for example, the detected flow rate of the flow rate sensor 23, the detected temperature of the temperature sensor 43, and the opening degree command value of the pressure regulating valve 42.

The pressure loss in the second exhaust pipe 40 is calculated based on, for example, the flow rate of the oxidizing gas and the temperature of the off-gas of the oxidizing gas. The control device 100 calculates the pressure loss in the second exhaust pipe 40 based on, for example, the detected flow rate of the flow rate sensor 23 and the detected temperature of the temperature sensor 43.

As shown in FIG. 2, in subsequent S6, the control device 100 determines whether the estimated value of the pressure in the muffler 44 calculated in S4 exceeds a predetermined threshold value. When the estimated value of the pressure in the muffler 44 exceeds a predetermined threshold value (YES in S6), the process proceeds to S8. In S8, the control device 100 turns on the muffler abnormality determination. The predetermined threshold value can be appropriately set. On the other hand, when the estimated value of the pressure in the muffler 44 does not exceed a predetermined threshold value (NO in S6), the processing of FIG. 2 ends.

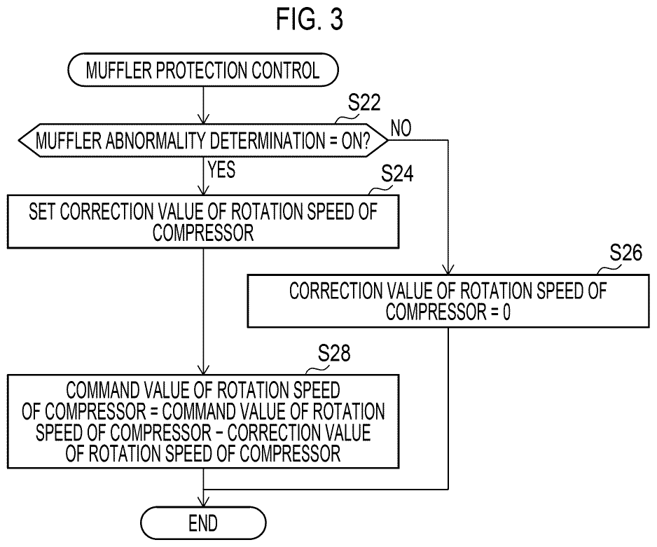

In S10 following S8, the control device 100 executes the muffler protection control. For example, the control device 100 reduces the rotation speed of the compressor 22 provided in the second air supply pipe 20. More specifically, with regard to the muffler protection control, as shown in FIG. 3, the control device 100 determines in S22 whether the muffler abnormality determination is in the on state. When the muffler abnormality determination is turned on in S8 (see FIG. 2) described above, the control device 100 determines YES in S22. When the muffler abnormality determination is in the on state (YES in S22), the process proceeds to S24, and when the muffler abnormality determination is not in the on state (NO in S22), the process proceeds to S26.

In S24 after YES in S22, the control device 100 sets the correction value of the rotation speed of the compressor 22. On the other hand, in S26 after NO in S22, the control device 100 sets the correction value of the rotation speed of the compressor 22 to zero.

In following S28, the control device 100 sets the command value of the rotation speed of the compressor 22 based on the correction value of the rotation speed of the compressor 22 set in S24 or S26. At this time, the command value of the rotation speed of the compressor 22=the command value of the rotation speed of the compressor 22−the correction value of the rotation speed of the compressor 22. That is, the command value of the rotation speed of the compressor 22 is the command value obtained by subtracting the correction value from the original command value. When the correction value is zero (see S26), the command value of the rotation speed of the compressor 22 is not reduced. The control device 100 outputs a command value set according to the correction value of the rotation speed of the compressor 22 to the compressor 22.

As a result, in a case where the muffler abnormality determination is in the on state (see S8 and S22), the rotation speed of the compressor 22 is reduced. When the rotation speed of the compressor 22 is reduced, the pressure of the oxidizing gas supplied to the fuel cell 4 through the second air supply pipe 20 is reduced, and accordingly, the pressure of the off-gas discharged from the fuel cell 4 is reduced. As a result, the pressure of the off-gas supplied to the muffler 44 is reduced, so that it is possible to prevent the muffler 44 from being damaged by the pressure of the off-gas.

### Effect

The fuel cell system 2 of the embodiment has been described above. As is clear from the above description, the fuel cell system 2 includes the second air supply pipe 20 that supplies the oxidizing gas to the fuel cell 4, the second exhaust pipe 40 that discharges the off-gas discharged from the fuel cell 4 to the outside, the muffler 44 provided in the second exhaust pipe 40, and the control device 100 that executes the muffler protection control when the estimated value of the pressure in the muffler 44 exceeds a predetermined threshold value.

With this configuration, the muffler protection control is executed when the estimated value of the pressure in the muffler 44 exceeds the threshold value, whereby it is possible to suppress the pressure in the muffler 44 from excessively increasing. As a result, it is possible to prevent the muffler 44 from being damaged.

In addition, the fuel cell system 2 includes a compressor 22 that pressurizes the oxidizing gas supplied to the fuel cell 4 and a pressure sensor 24 that detects a pressure of the oxidizing gas pressurized by the compressor 22. The control device 100 calculates an estimated value of the pressure in the muffler 44 based on the detected pressure of the pressure sensor 24. With this configuration, the pressure in the muffler 44 can be accurately estimated.

The control device 100 executes the muffler protection control by reducing the rotation speed of the compressor 22. With this configuration, the pressure in the muffler 44 can be reliably reduced, and the muffler 44 can be prevented from being damaged.

In addition, according to the fuel cell system 2 of the embodiment, since an additional sensor or actuator is not needed, cost can be reduced and the size can be reduced. In addition, in a case where the temporary blockage of the muffler 44 due to freezing or the like is recovered, the muffler protection control returns to the normal control, so that no response such as repair is needed.

### MODIFICATION

When the control device 100 controls the rotation speed of the compressor 22, the control device 100 may control the rotation speed of the compressor 22 by feedback control based on the detected flow rate of the flow rate sensor 23. That is, the control device 100 may control the rotation speed of the compressor 22 by feedback control based on the flow rate of the oxidizing gas supplied to the fuel cell 4.

In another modification, the control device 100 may control the rotation speed of the compressor 22 by feedback control based on the output current of the fuel cell 4 when controlling the rotation speed of the compressor 22.

Although specific examples of the aspect of the disclosure have been described above in detail, the examples are merely illustrative and are not intended to limit the scope of the claims. The technology described in the claims includes various modifications and changes of the specific examples exemplified above. The technical elements described in the present specification or the drawings exhibit technical usefulness alone or in various combinations, and are not limited to the combinations described in the claims at the time of filing. Moreover, the technology exemplified in the present specification or the drawings can achieve a plurality of objectives at the same time, and achieving one of the objectives has technical usefulness.

What is claimed is:

1. A fuel cell system comprising:
a fuel cell;
an air supply pipe configured to supply an oxidizing gas to the fuel cell;
an exhaust pipe configured to discharge an off-gas discharged from the fuel cell to an outside;
a muffler provided in the exhaust pipe; and
a control device configured to execute muffler protection control when an estimated value of a pressure in the muffler exceeds a threshold value that is predetermined.

2. The fuel cell system according to claim 1, further comprising:
a compressor provided in the air supply pipe, the compressor being configured to pressurize the oxidizing gas supplied to the fuel cell; and
a pressure sensor configured to detect a pressure of the oxidizing gas pressurized by the compressor, wherein the control device is configured to calculate the estimated value of the pressure in the muffler based on the detected pressure of the pressure sensor.

3. The fuel cell system according to claim 2, wherein the control device is configured to execute the muffler protection control by reducing a rotation speed of the compressor.
